(19) United States
(12) Patent Application Publication
(10) Pub. No.: US 2024/0260016 A1
(43) Pub. Date: Aug. 1, 2024

(54) COMMUNICATION APPARATUS AND METHOD FOR CONTROLLING THE SAME, AND STORAGE MEDIUM

(71) Applicant: CANON KABUSHIKI KAISHA, Tokyo (JP)

(72) Inventor: EIGORO INA, Kanagawa (JP)

(21) Appl. No.: 18/419,984

(22) Filed: Jan. 23, 2024

(30) Foreign Application Priority Data
Jan. 27, 2023 (JP) 2023-011218

(51) Int. Cl. H04W 72/0453; H04B 17/318; H04L 5/00; H04W 84/12

(52) U.S. Cl. CPC H04W 72/0453; H04B 17/328; H04L 5/0007; H04W 84/12

(57) ABSTRACT

A communication apparatus that performs wireless communication compliant with an IEEE 802.11 standard, executes allocation processing for allocating individual frequency resources to a plurality of user terminals. The communication apparatus controls communication such that OFDMA communication with the plurality of user terminals is performed using respective frequency resources allocated to the plurality of user terminals in the allocation processing. In the allocation processing, a frequency resource closer to an edge of a usable frequency band is allocated to a user terminal, among the plurality of user terminals, that corresponds to a lower transmission output, and a frequency resource farther from the edge is allocated to a user terminal, among the plurality of user terminals, that corresponds to a higher transmission output.

### BACKGROUND

### Field of the Disclosure

The present disclosure relates to a communication apparatus that performs wireless communication, a method for controlling the same, and a storage medium.

### Description of the Related Art

The IEEE 802.11 standard series is known as a wireless local area network (“wireless LAN” or “WLAN”) communication standard developed by the Institute of Electrical and Electronics Engineers (IEEE). The IEEE 802.11 standard series includes standards such as the IEEE 802.11a/b/g/n/ac/ax standards. For example, in the IEEE 802.11ax (HE: High Efficiency) standard, techniques using Orthogonal Frequency Division Multiple Access (OFDMA) for improving communication speeds under congested conditions in addition to providing high peak throughput of up to 9.6 gigabits per second (Gbps) have been standardized (see Japanese Patent Laid-Open No. 2018-50133).

Products equipped with wireless LAN communication functions compliant with the IEEE 802.11 standard series must also meet regulations stipulated by the radio laws in effect in each country. Generally, radio laws specify regulatory values not only for the strength of wireless signals at the frequencies authorized for use, but also for the power leaking into frequencies other than the target frequency. In the United States, the Federal Communication Commission (FCC) regulates wireless communications under Title 47 of the Code of Federal Regulations (CFR). 47 CFR 15, which is defined for wireless frequency devices that can be operated without a license, is applied to wireless LAN communication in the 2.4 GHz band.

Section 209 of 47 CFR 15 (47 CFR 15.209) establishes an upper limit value for out-of-band radio strength. Section 205 of 47 CFR 15 (47 CFR 15.205) establishes frequencies at which the upper limit value established in 47 CFR 15.209 are to be observed. For the frequencies used in wireless LAN communication in the 2.4 GHz band, 47 CFR 15.205 defines 2390 MHz as the closest frequency to the low-frequency side and 2483.5 MHz as the closest frequency to the high-frequency side. According to 47 CFR 15.209, an upper limit value of 500 μV/m is established for the radio strength (average field strength) at these frequencies. Note that the upper limit value of 500 μV/m is an average value, and the peak value must be within 20 dB from the average value. The upper limit value of the radio strength at the stated frequencies set by the FCC establish a much stricter limitation than the standards in Japan and Europe.

In a case of using the lowest frequency of 2412 MHz (CH1) or the highest frequency of 2462 MHz (CH11) as the center frequency of wireless LAN communication in the 2.4 GHz band, there have been situations where the transmission output is lower than in a case where other frequencies are used. This is to comply with the FCC regulations described above, and if CH1 or CH11 is used with the same transmission output as in a case where other frequencies are used, the output may exceed the regulatory value of the transmission power set by the FCC. However, Japan and Europe do not have the kind of strict regulations set by the FCC, and therefore no situations arise where the transmission output is changed for each frequency used for wireless LAN communication.

If it is impossible to avoid lowering the transmission output when using a specific frequency in wireless LAN communication in order to comply with FCC regulations as described above, the strength of the signals reaching the communication device on the receiving side will drop due to the drop in the transmission output. This leads to a drop in the signal-to-noise ratio (S/N) in the communication device on the receiving side. As a result, a drop in the communication speed may occur due to the inability to use a modulation scheme having a high modulation level, such as 1024 Quadrature Amplitude Modulation (QAM), for example. In addition, retransmissions or communication interruptions may occur often due to reception errors.

### SUMMARY

Accordingly, the present disclosure provides a technique which makes it possible to use the required transmission output for each of user terminals by more appropriately allocating frequency resources in OFDMA communication.

According to one aspect of the present disclosure, there is provided a communication apparatus that performs wireless communication compliant with an IEEE 802.11 standard, the communication apparatus comprising: at least one memory that stores a set of instructions; and at least one processor that executes the instructions, the instructions, when executed, causing the communication apparatus to perform operations comprising: executing allocation processing for allocating individual frequency resources to a plurality of user terminals; and controlling communication such that OFDMA communication with the plurality of user terminals is performed using respective frequency resources allocated to the plurality of user terminals in the allocation processing, wherein in the allocation processing, a frequency resource closer to an edge of a usable frequency band is allocated to a user terminal, among the plurality of user terminals, that corresponds to a lower transmission output, and a frequency resource farther from the edge is allocated to a user terminal, among the plurality of user terminals, that corresponds to a higher transmission output.

According to another aspect of the present disclosure, there is provided a method for controlling a communication apparatus that performs wireless communication compliant with an IEEE 802.11 standard, the method comprising: executing allocation processing for allocating individual frequency resources to a plurality of user terminals; and controlling communication such that OFDMA communication with the plurality of user terminals is performed using respective frequency resources allocated to the plurality of user terminals in the allocation processing, wherein in the allocation processing, a frequency resource closer to an edge of a usable frequency band is allocated to a user terminal, among the plurality of user terminals, that corresponds to a lower transmission output, and a frequency resource farther from the edge is allocated to a user terminal, among the plurality of user terminals, that corresponds to a higher transmission output.

According to still another aspect of the present disclosure, there is provided a non-transitory storage medium storing a program for causing a computer to execute a method for controlling a communication apparatus that performs wireless communication compliant with an IEEE 802.11 standard, the method comprising: executing allocation processing for allocating individual frequency resources to a plurality of user terminals; and controlling communication such that OFDMA communication with the plurality of user terminals is performed using respective frequency resources allocated to the plurality of user terminals in the allocation processing, wherein in the allocation processing, a frequency resource closer to an edge of a usable frequency band is allocated to a user terminal, among the plurality of user terminals, that corresponds to a lower transmission output, and a frequency resource farther from the edge is allocated to a user terminal, among the plurality of user terminals, that corresponds to a higher transmission output.

Further features of various embodiments of the present disclosure will become apparent from the following description of exemplary embodiments (with reference to the attached drawings).

### BRIEF DESCRIPTION OF THE DRAWINGS

FIG. 1 is a diagram illustrating an example of the configuration of a wireless network.

FIG. 2 is a block diagram illustrating an example of the hardware configuration of an AP.

FIG. 3 is a block diagram illustrating an example of the functional configuration of the AP.

FIG. 4 illustrates an example of the frequency spectrum of a signal transmitted by the AP.

FIG. 5 illustrates an example of the frequency spectrum of a signal transmitted by the AP.

FIG. 6 is a flowchart illustrating a sequence of data frame transmission processing performed by the AP.

### DESCRIPTION OF THE EMBODIMENTS

Hereinafter, embodiments will be described in detail with reference to the attached drawings. Note, the following embodiments are not intended to limit the scope of every embodiment. Multiple features are described in the embodiments, but limitation is not made to an embodiment that requires all such features, and multiple such features may be combined as appropriate. Furthermore, in the attached drawings, the same reference numerals are given to the same or similar configurations, and redundant description thereof is omitted.

### Network Configuration

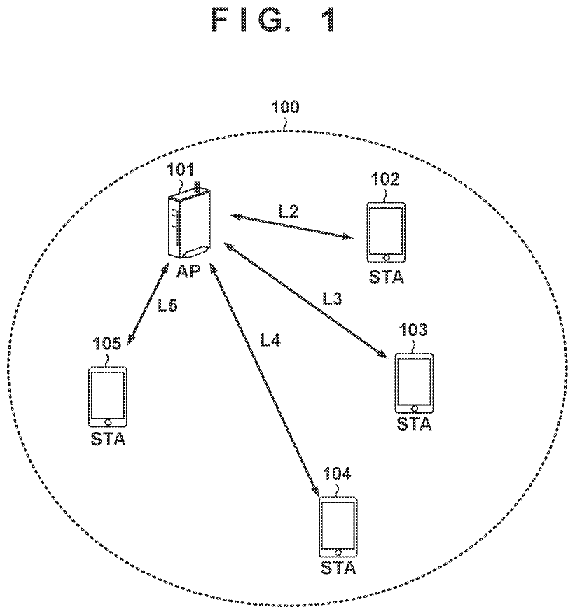

FIG. 1 illustrates an example of the configuration of a wireless network according to an embodiment of the present disclosure. A communication apparatus 101 (AP 101) is an access point (AP) that has the role of constructing a wireless network 100. Communication apparatuses 102 to 105 (STAs 102 to 105) are stations (STAs) that have the role of connecting to the wireless network 100 constructed by an AP (the communication apparatus 101), and are examples of user terminals. Although a network constituted by one AP and four STAs is illustrated in FIG. 1, the number of APs and the number of STAs are not limited thereto.

The communication apparatuses 101 to 105 support the IEEE 802.11ax (HE: High Efficiency) standard, which is one wireless LAN communication standard, and are capable of executing wireless communication compliant with the IEEE 802.11ax standard. In addition, each communication apparatus is configured to be capable of performing wireless communication in multiple frequency bands (2.4 GHz, 5 GHz, and 6 GHz bands, in the present embodiment). The frequency bands that each communication apparatus can use are not limited to these, and different frequencies may be used, such as the 60 GHz band or the like, for example. In addition, each communication apparatus is configured to be capable of communicating using a bandwidth of 20 MHz, 40 MHz, 80 MHz, 160 MHz, 320 MHz, and the like. The bandwidths that each communication apparatus can use are not limited to these, and different bandwidths may be used, such as 240 MHz and 4 MHz, for example.

The communication apparatuses 101 to 105 can implement multi-user (MU) communication by executing Orthogonal Frequency Division Multiple Access (OFDMA) communication compliant with the IEEE 802.11ax standard. Multi-user communication is communication that multiplexes the signals of multiple users. In OFDMA communication, the usable frequency band is divided into a plurality of resource units (RUs), and each RU is allocated to the STAs such that the RUs do not overlap between the STAs. Each RU is a frequency resource constituted by a set of consecutive plurality of subcarriers. Unused subcarriers are provided as guard bands between adjacent RUs. Accordingly, the AP (the communication apparatus 101) can perform multi-user communication for communicating with a plurality of STAs (two or more of the communication apparatuses 102 to 105) at the same time.

In the present embodiment, the communication apparatuses 101 to 105 support at least the IEEE 802.11ax standard in the IEEE 802.11 standard series. The communication apparatuses 101 to 105 may further support at least one legacy standard in the IEEE 802.11 standards prior to the IEEE 802.11ax standard. The legacy standards are the IEEE 802.11a/b/g/n/ac standards. The communication apparatuses 101 to 105 may further be compliant with a successor standard to IEEE 802.11ax, such as the IEEE 802.11be (EHT: Extremely High Throughput or Extreme High Throughput) standard, among the IEEE 802.11 standard series.

In addition to the IEEE 802.11 standard series, the communication apparatuses 101 to 105 may support other communication standards such as Bluetooth™, Near Field Communication (NFC), Ultra Wide Band (UWB), Zigbee, Multi Band OFDM Alliance (MBOA), or the like. UWB includes wireless USB, wireless 1394, WiNET (WiMedia Network), and the like. The communication apparatuses 101 to 105 may further support communication standards for wired communication, such as wired LAN or the like.

The communication apparatuses 101 to 105 may also be capable of executing Multiple-Input and Multiple-Output (MIMO) communication. In this case, each of the communication apparatuses 101 to 105 has a plurality of antennas. The transmission-side communication apparatus transmits signals in different streams from the plurality of antennas with the same frequency channel. The reception-side communication apparatus receives all the signals of the plurality of streams simultaneously using the plurality of antennas, and separates and decodes the signals of the streams. In this manner, by executing MIMO communication, the communication apparatuses 101 to 105 can transmit and receive more data in the same amount of time than in a case of not executing MIMO communication.

The communication apparatus 101 (AP 101) can be a wireless LAN router, a personal computer (PC), or the like, for example, but is not limited thereto. The communication apparatuses 102 to 105 (STAs 102 to 105) can be cameras, tablet terminals, smartphones, PCs, cell phones, video cameras, headsets, printers, or the like, for example, but are not limited thereto. The communication apparatuses 101 to 105 may be information processing apparatuses including wireless chips or the like capable of executing wireless communication compliant with the IEEE 802.11ax standard.

### AP Hardware Configuration

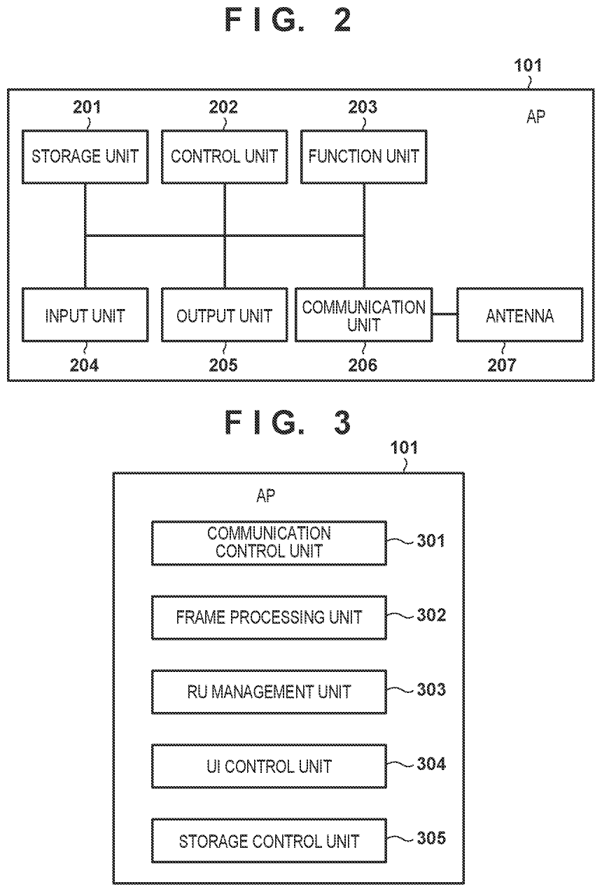

FIG. 2 is a block diagram illustrating an example of the hardware configuration of the communication apparatus 101 (the AP 101). The AP 101 includes a storage unit 201, a control unit 202, a function unit 203, an input unit 204, an output unit 205, a communication unit 206, and an antenna 207. Note that the communication apparatuses 102 to 105 (the STAs 102 to 105) can have the same hardware configuration as the communication apparatus 101, but some of the configuration (for example, the configurations of the input unit 204 and the output unit 205) may be different from that of the communication apparatus 101.

The storage unit 201 is constituted by at least one memory, such as a Read Only Memory (ROM) and/or a Random Access Memory (RAM). The storage unit 201 stores various information such as computer programs for performing various operations (described later), communication parameters for wireless communication, and the like. Other types of storage media, such as flexible disks, hard disks, optical disks, magneto-optical disks, CD-ROMs, CD-Rs, magnetic tape, non-volatile memory cards, DVDs, and the like, may be used for the one or more of the memories constituting the storage unit 201. The storage unit 201 may include a plurality of memories and the like.

The control unit 202 is constituted by one or more processors such as a Central Processing Unit (CPU) and/or a Micro Processing Unit (MPU). The control unit 202 controls the AP 101 as a whole by reading out and executing the computer programs stored in the storage unit 201. The control unit 202 may be configured to control the AP 101 as a whole in cooperation with the computer programs and an operating system (OS) stored in the storage unit 201. The control unit 202 may include a plurality of processors, e.g., may be multi-core, and may be configured to control the AP 101 as a whole using the plurality of processors.

The control unit 202 generates data or signals (wireless frames) to be transmitted in communication with other communication devices. The control unit 202 further controls the function unit 203 to execute predetermined processing, such as wireless communication, image capturing, printing, projection, and the like. The function unit 203 is hardware for the AP 101 to execute the predetermined processing.

The input unit 204 accepts various operations from a user. The output unit 205 makes various outputs to the user through a monitor screen or a speaker. Here, the output by the output unit 205 can be one or more of a display on the monitor screen, audio output through the speaker, vibration output, and the like. The input unit 204 and the output unit 205 may be implemented as a single module, such as a touchscreen. Additionally, the input unit 204 and the output unit 205 may each be configured as an integral part of the AP 101, or separate from the AP 101.

The communication unit 206 controls wireless communication compliant with the IEEE 802.11ax standard. The communication unit 206 controls the antenna 207 to transmit and receive signals for wireless communication generated by the control unit 202. The AP 101 transmits and receives various data, such as image data, document data, video data, and the like, through communication with the STAs 102 to 105 via the communication unit 206.

Note that in addition to the IEEE 802.11ax standard, the communication unit 206 may be configured to control wireless communication compliant with other standards in the IEEE 802.11 standard series, as well as wired communication over a wired LAN or the like. If the AP 101 supports an NFC standard, a Bluetooth standard, or the like in addition to the IEEE 802.11ax standard, the communication unit 206 may also be configured to control wireless communication compliant with those communication standards. If the AP 101 is configured to be capable of executing wireless communication compliant with a plurality of communication standards, the AP 101 may include separate communication units and antennas for the different communication standards.

The antenna 207 is an antenna capable of communication in a predetermined frequency band (the 2.4 GHz, 5 GHz, and 6 GHz bands, in the present embodiment). The AP 101 in the present embodiment includes one antenna, but may include separate antennas for each frequency band. If the AP 101 includes a plurality of antennas, a corresponding communication unit 206 may be provided for each antenna. The antenna 207 may be provided separately from the communication unit 206 as illustrated in FIG. 2, or may be configured as a single module together with the communication unit 206.

### Functional Configuration of AP

FIG. 3 is a block diagram illustrating an example of the functional configuration of the communication apparatus 101 (the AP 101). The AP 101 includes at least one communication control unit 301, a frame processing unit 302, an RU management unit 303, a UI control unit 304, and a storage control unit 305 as functional units.

The communication control unit 301 controls communication with an external apparatus, such as the STA 102, by controlling the communication unit 206. The communication control unit 301 transmits wireless frames, including frames generated by the frame processing unit 302, receives wireless frames from partner apparatuses, and passes received wireless frames to the frame processing unit 302.

The frame processing unit 302 performs processing pertaining to frames for wireless communication performed by the communication control unit 301. Specifically, the frame processing unit 302 generates frames to be transmitted to the partner apparatus. The frame processing unit 302 configures the frames to be generated in accordance with setting data stored in the storage unit 201. The frame processing unit 302 also analyzes frames received from the partner apparatus by the communication control unit 301.

The RU management unit 303 manages and controls RUs in a case where the AP 101 performs communication using OFDMA (OFDMA communication). The RU management unit 303 allocates frequency resources (RUs) used by each STA for transmitting and receiving wireless frames, and adjusts the signal strength of each RU. The IEEE 802.11ax standard defines a range of adjustment for the voltage of the transmission signal for each RU when the AP allocates RUs to a plurality of STAs and transmits the signals simultaneously using that plurality of RUs. Specifically, the standard specifies that the voltage of the transmission signal for each RU can be adjusted over a range of 0.5 times to 2 times a signal voltage serving as a reference (in the case of the signal power, a range of 0.25 times (−6 dB) to 4 times (+6 dB), i.e., within ±6 dB).

The signal strength for each RU is adjusted mainly for the following two purposes. The first is to avoid wasting power by using a higher transmission power than is necessary, thereby reducing the power consumed by the communication device. The second is to increase the communication capacity for the entire space to avoid situations where a signal transmitted at a higher transmission power than necessary acts as radio interference for other nearby communication devices.

The UI control unit 304 controls the input unit 204 and the output unit 205 to accept user operations through a touch panel or the like, and to output information to the user (through displays in a screen, outputting audio, or the like). For example, using a screen displayed by the output unit 205, the UI control unit 304 accepts touch panel operations from the user through the input unit 204. The UI control unit 304 makes various types of settings in accordance with the accepted user operations, and saves setting data indicating the settings in the storage unit 201 through the storage control unit 305.

The storage control unit 305 accesses the storage unit 201 in response to instructions from other functional units. The storage control unit 305 saves data in the storage unit 201 and reads out data from the storage unit 201.

### Example of Transmission Output Regulations

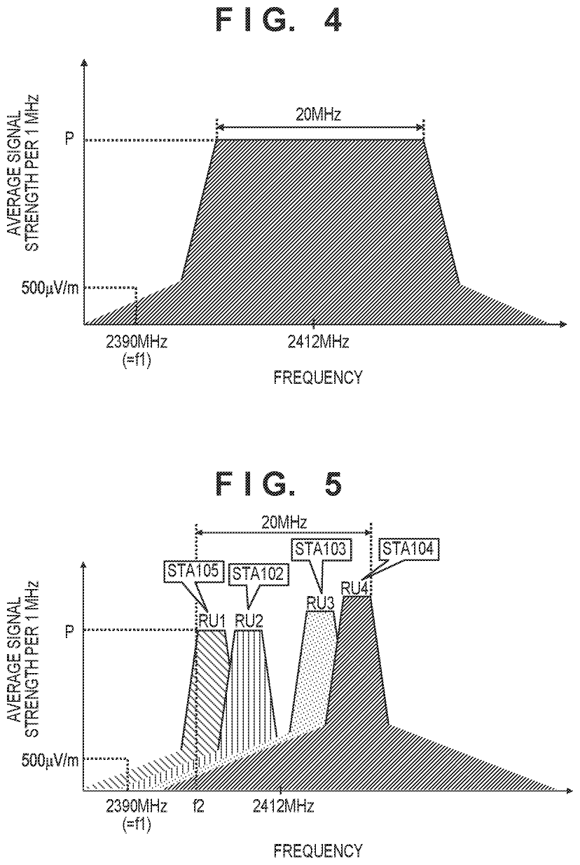

FIG. 4 illustrates a frequency spectrum in which the average signal strength per 1 MHz is approximately uniform at P, as an example of the frequency spectrum of an OFDM signal (OFDMA signal) transmitted by the AP 101 according to the present embodiment. In the present example, the AP 101 transmits an OFDM signal having a center frequency of 2412 MHz and a frequency band having a width of 20 MHz, as illustrated in FIG. 4. This center frequency of 2412 MHz is the center frequency of one communication channel (CH1) among a plurality of communication channels for wireless LAN communication in the 2.4 GHz band.

Of the IEEE 802.11 standard series, the transmission signal in communication through the IEEE 802.11a/g/n standard using OFDM has a frequency spectrum approximately equivalent to the frequency spectrum illustrated in FIG. 4. Furthermore, in communication using the IEEE 802.11ax standard, in a case where the AP communicates with a single user terminal (STA), the transmission signal has a frequency spectrum such as that illustrated in FIG. 4. On the other hand, in a case where the AP performs communication with a plurality of STAs (multi-user communication), the transmission signal may have a frequency spectrum in which the transmission power differs for each RU (as illustrated in FIG. 5, which will be described later).

In the IEEE 802.11 standard series, spectral flatness regulations are provided so that variations in signal strength within the frequency band (use band) used for transmitting OFDM signals (OFDMA signals) fall within a set range. Specifically, the signal strength is limited to within ±4 dB at frequencies close to the center frequency and within +4 dB/−6 dB at frequencies relatively far from the center frequency. Such spectrum flatness regulates the signal strength in a 20 MHz-wide use band so as to be flat, as indicated by the frequency spectrum illustrated in FIG. 4.

In addition, the regulations for signal strength at frequencies outside the use band (out-of-band frequencies) are stipulated by the radio laws of each country, as mentioned above. For example, the FCC regulations in the United States set 500 μV/m as the regulatory value (upper limit value) for the average field strength per 1 MHz at frequencies below 2390 MHz. Generally, for communication partners farther away, it may be necessary to increase the transmission signal strength as much as possible to enable communication using a modulation scheme having a higher modulation level. However, regulating the signal strength in out-of-band frequencies can make it difficult to increase the transmission signal strength.

For example, with the frequency spectrum illustrated in FIG. 4, the average field strength in the out-of-band frequency of 2390 MHz does not exceed the regulatory value of 500 μV/m so as to comply with such regulations. In this example, if the average signal strength in the 20 MHz-wide use band is increased beyond P, the average signal strength in the out-of-band frequency will increase due to the sidelobe level of the transmission signal increasing accordingly. The average field strength in the out-of-band frequency of 2390 MHz may therefore exceed the regulatory value of 500 μV/m. For this reason, it is necessary to limit the transmission signal strength in the use band according to the regulations for signal strengths in out-of-band frequencies. Such regulations have given rise to cases where the transmission signal strength (transmission output) is intentionally reduced compared to other communication channels, such as in a communication channel located at an end of the frequency band usable in the 2.4 GHz band (e.g., CH1 or CH11).

In this manner, in a case where an AP communicates with a single user terminal, the transmission signal is generated so as to have a flat frequency spectrum in accordance with spectrum flatness regulations. In a communication channel located at an end of the usable frequency band, it may be necessary to reduce the transmission output over the entire (20 MHz-wide) use band of the channel beyond that of other communication channels to comply with the regulations for signal strengths in out-of-band frequencies, as described above.

On the other hand, in a case where communicating with a plurality of user terminals in accordance with the IEEE 802.11ax standard, individual transmission outputs for each user terminal (RU) can be adjusted within a range of ±6 dB. This is done to reduce the power consumed by the communication devices and reduce unnecessary radio interference for other communication devices, as mentioned above. In the present embodiment, even in a communication channel located at an end of the usable frequency band (e.g., CH1 or CH11), such an adjustment of the transmission output for each RU makes it possible to ensure a sufficient transmission output for user terminals that require a higher transmission output. This makes it possible to prevent the communication quality in such a communication channel from dropping lower than cases where the RUs of other communication channels are used.

### Example of Transmission Output Adjustment for Each RU

FIG. 5 illustrates an example of the frequency spectrum of the OFDMA signal transmitted by the AP 101 according to the present embodiment. In the present example, the AP 101 performs multi-user communication with the STAs 102 to 105 through OFDMA using a communication channel having a center frequency of 2412 MHz and located at the low frequency-side end of the usable frequency band in the 2.4 GHz band (CH1). This communication channel has 20 MHz-wide frequency band. The multi-user communication with the STAs 102 to 105 is performed using a plurality of RUs (frequency resources) obtained by dividing the 20 MHz-wide frequency band.

In the example illustrated in FIG. 5, individual RUs are allocated to corresponding ones of the STAs 102 to 105, and different transmission signal strengths are used for the respective RUs by adjusting the transmission signal strength (transmission output) for each RU. Here, the transmission signal strength of each of the plurality of RUs constituting the OFDMA signal is set to satisfy the regulations for signal strengths in a predetermined out-of-band frequency f1. In other words, the transmission signal strength of each RU is set such that the average signal strength in the out-of-band frequency f1 is no greater than the regulatory value (upper limit value). This regulatory value is stipulated by the radio laws of each country, as mentioned above. FIG. 5 indicates a regulatory value of 500 μV/m for the average field strength in the out-of-band frequency of 2390 MHz stipulated by the FCC regulations in the United States.

The signal strength in the out-of-band frequency f1 depends on the sidelobe level in the out-of-band frequency f1 for the signal transmitted in each RU in the usable frequency band. The contribution of the signal transmitted in each RU to the signal strength in the out-of-band frequency f1 (=2390 MHz) decreases as the frequency of the RU deviates from the out-of-band frequency f1. In the example in FIG. 5, the contribution to the signal strength in the out-of-band frequency f1 decreases in the order of RU1, RU2, RU3, and RU4.

For example, in the example in FIG. 5, assume that the transmission signal strength of RU4, which among RU1 to RU4 is farthest from the out-of-band frequency f1, is increased by several dB based on the average signal strength P in a case of communicating with a single user terminal (FIG. 4). In this case, it is assumed that the signal strength in the out-of-band frequency f1 will experience almost no change, and will not exceed the predetermined regulatory value. It is therefore possible to use a transmission signal strength (transmission output) that is higher than the reference signal strength P in at least some of the RUs of the communication channel, even for a communication channel located at the end of the usable frequency band (CH1).

On the other hand, if, for example, the transmission signal strength of RU1, which among RU1 to RU4 is closest to the out-of-band frequency f1, is increased beyond the reference signal strength P, the signal strength in the out-of-band frequency f1 may exceed the predetermined regulatory value as a result. This is because, the signal transmitted in RU1 contributes a large amount to the signal strength in the out-of-band frequency f1, as indicated in FIG. 5. For this reason, for RUs that are close to the out-of-band frequency f1, such as RU1, it may be necessary to adjust the transmission signal strength such that the regulatory value for the signal strength or not use those RUs in the out-of-band frequency f1 is satisfied, e.g., such that the strength is lower than the reference signal strength P.

Accordingly, the AP 101 in the present embodiment adjusts the transmission output (transmission signal strength) of each RU such that a higher transmission output is used for RUs farther from the edges of the usable frequency band (also called “band edges” hereinafter). The farther the RU is from a band edge, the farther the RU is from the out-of-band frequency f1.

In the example in FIG. 5, the AP 101 adjusts the transmission output for each of the RU1 to the RU4 such that a higher transmission output is used as the RU is farther from the band edge. In other words, if the band edge frequency is represented by f2, the AP 101 causes a higher transmission output to be used for the RU1 to the RU4 as the frequency difference from the band edge frequency f2 increases. Specifically, the highest transmission output is used in RU4, which, among RU1 to RU4, is farthest from the band edge (the farthest from the out-of-band frequency f1). The lowest transmission output is used for RU1 which is closest to the band edge (i.e., closest to the out-of-band frequency f1).

### RU Allocation Processing

In a case where the AP 101 performs OFDMA communication with a plurality of STAs (user terminals), the RU management unit 303 of the AP 101 allocates individual RUs (frequency resources) to the plurality of STAs (user terminals). The communication control unit 301 controls the communication unit 206 to perform OFDMA communication with the plurality of STAs using respective RUs allocated to the plurality of STAs by the RU management unit 303.

In the present embodiment, the RU management unit 303 performs allocation processing for, among a plurality of STAs (user terminals), allocating RUs (frequency resources) closer to the edges of the usable frequency band to STAs corresponding to lower transmission outputs, and allocating RUs farther from the edges to STAs corresponding to higher transmission outputs. This makes it possible to use the required transmission output for each STA (use sufficient transmission outputs for STAs that require higher transmission outputs) while satisfying the regulations for signal strengths in the out-of-band frequency f1.

When performing OFDMA communication with a plurality of STAs (user terminals), the RU management unit 303 may perform processing to determine a transmission output value for each of the plurality of STAs. For example, as in the example described below, the RU management unit 303 determines a transmission output value for each of the plurality of STAs based on the distance between each of the plurality of STAs and the AP 101. Because spatial loss between an STA and the AP 101 increases as the distance between the STA and the AP 101 increases, a higher transmission output (a stronger transmission signal strength) is required for that STA. Therefore, for the plurality of STAs that are communication partners in the OFDMA communication, the RU management unit 303 may determine a higher transmission output value as the distance from the AP 101 increases.

In a case where a plurality of STAs 102 to 105 are connected to the AP 101 as illustrated in FIG. 1, the distance from the AP 101 may be different for each STA. For example, in the example in FIG. 1, distances L2 to L5 between each of the STAs 102 to 105 and the AP 101 are L5<L2<L3<L4. Note that this example assumes that the antenna gain and the performance of the reception function are the same for each STA, and that the AP 101 transmits the OFDMA signal in an omnidirectional radiation pattern. In this case, the RU management unit 303 determines a higher transmission output value for the STAs 102 to 105 in order from the STA at the greatest distance from the AP 101. The highest transmission output value (transmission signal strength) is therefore determined for the STA 104, and the lowest transmission output value is determined for the STA 105, as in the example in FIG. 5.

In accordance with such transmission output determination, in the RU allocation processing, the RU management unit 303 allocates RUs (frequency resources) farther from the band edge to the plurality of STAs 102 to 105 in order from the highest determined transmission output value. In the example illustrated in FIG. 5, RU4, which is farthest from the band edge frequency f2, is allocated to the STA 104, for which the highest transmission output value has been determined. RU1, which is closest to the band edge frequency f2, is allocated to the STA 105, for which the lowest transmission output value has been determined.

In this manner, in the case of performing OFDMA communication with a plurality of STAs (user terminals), the AP 101 in the present embodiment allocates RUs which are farther from the band edge, and through which higher transmission outputs can be used, to STAs that require higher transmission outputs. This makes it possible to ensure sufficient transmission output for STAs that require high transmission outputs, even in cases of using a communication channel located at the band edge. It is therefore possible to maintain the communication quality in such communication channels compared to cases where RUs of other communication channels are used, while satisfying the regulations for signal strengths in a predetermined out-of-band frequency.

Note that in the example in FIG. 5, CH1 is used as a channel located at the end of the usable frequency band in the 2.4 GHz band. However, allocation processing similar to that described above can be used as the RU allocation processing, and similar advantages can be achieved, even in cases of using another communication channel as the communication channel located at the end of the usable frequency band. For example, in a case where CH11 in the 2.4 GHz band is used, the out-of-band frequency stipulated by FCC regulations is 2483.5 MHz. For CH36 and CH64 in the 5 GHz band, the out-of-band frequencies stipulated by FCC regulations are 5150 MHz and 5310 MHz, respectively.

In addition, the upper limit value (regulatory value) for the signal strength in out-of-band frequencies stipulated by radio laws differs from country to country. For this reason, for example, RUs may be allocated to STAs through the above-described allocation processing in countries where FCC regulations are in effect, whereas RUs may be allocated to STAs through other processing in countries where FCC regulations are not in effect. In other words, the AP 101 (the RU management unit 303) may be configured to allocate individual frequency resources to a plurality of STAs (user terminals) through the above-described allocation processing only in a case where that AP (communication apparatus) is used in a specific country.

Additionally, in a case where a communication channel sufficiently far from a predetermined out-of-band frequency is used, the above-described allocation processing need not be applied as the processing through which the AP 101 allocates RUs to each STA (user terminal). This is because the farther the communication channel used is from the out-of-band frequency, the smaller the difference is between the RUs in the communication channel, in terms of the influence of the sidelobe level of the transmission signal on the signal strength in the out-of-band frequency. The AP 101 (the RU management unit 303) may therefore be configured to allocate individual frequency resources to the plurality of STAs through the above-described allocation processing only in a case where OFDMA communication is performed using a specific communication channel in the usable frequency band. The RUs may be allocated to the STAs through other processing in a case where another communication channel is used.

### Setting Maximum Value of Transmission Output

In the present embodiment, the AP 101 may set an individual maximum value for each RU (frequency resource) used in OFDMA communication in advance in order to adjust the transmission output for each RU as described above. In this case, when setting the maximum value of the transmission output for each RU (frequency resource) used in the OFDMA communication, higher maximum values are set for RUs farther from the band edge. The maximum value of the transmission output is set such that the signal strength in the predetermined out-of-band frequency (f1, in FIG. 5) does not exceed the regulatory value as a result of the use of each RU (frequency resource) in OFDMA communication. Allocating transmission output values no greater than the maximum value for each RU to the STAs as a result of such settings makes it possible to ensure that the STA using the RU does not result in the transmission output value exceeding the regulatory value.

As described above, OFDMA communication is performed using a plurality of RUs (frequency resources) included in a single communication channel in the usable frequency band. In the present embodiment, the maximum value of the transmission output across all RUs in a single communication channel in a case where OFDMA communication with a plurality of STAs is performed, may be greater than in a case where OFDM communication is performed with a single user terminal using that communication channel. This makes it possible to select a more efficient modulation scheme for each RU, which can be expected to improve the communication speed. Note that the maximum value of the transmission output across all RUs in a single communication channel may be the average or the sum of the maximum values of the transmission outputs set for the RUs, or may be a maximum value among the maximum values of the transmission outputs set for the RUs.

### Processing Sequence

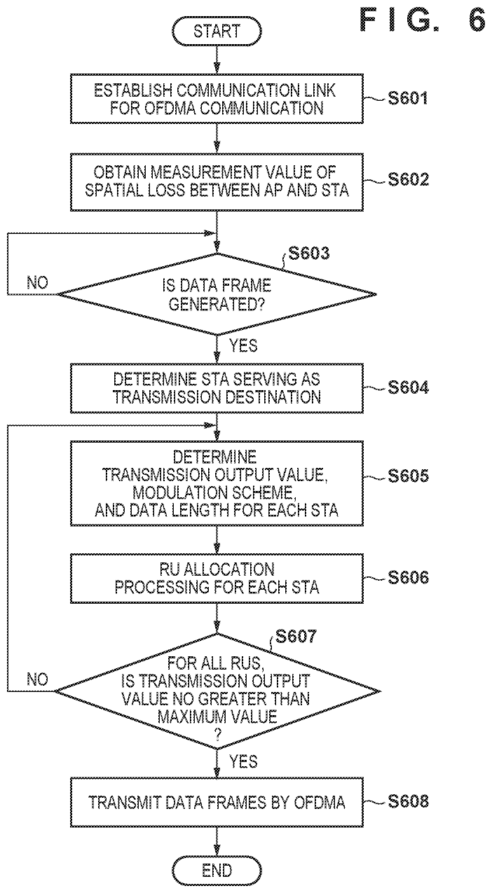

FIG. 6 is a flowchart illustrating a sequence of data frame transmission processing performed by the AP 101 in the present embodiment, including the allocation processing in which the AP 101 allocates individual frequency resources (RUs) to a plurality of user terminals (STAs 102 to 105).

When the processing according to the procedure in FIG. 6 is started, in step S601, the AP 101 establishes a communication link for performing OFDMA communication with the STAs. Next, in step S602, for each of the plurality of STAs, the AP 101 obtains a measurement value of spatial loss between the AP 101 and the STA, based on the difference between the strength of a signal transmitted by the AP 101 and the strength of the signal received by the STA. The measurement value of the strength of the signal received by each of the STAs can be obtained by feeding back of the measurement value from each of the STAs. Note that the measurement value of the spatial loss corresponds to a measurement value related to the distance between the AP 101 and each of the plurality of user terminals (STAs 102 to 105).

Next, in step S603, the AP 101 stands by until a data frame for downlink transmission through OFDMA communication is generated, and when the data frame is generated, advances the processing to step S604. In step S604, the AP 101 determines one or more STAs to which the generated data frame is to be transmitted. After determining the transmission destination, in step S605, for each STA that is to be a transmission destination, the AP 101 determines a transmission output value for transmitting data to the STA, based on the measurement value obtained in step S602. The AP 101 further determines a modulation scheme and a data length for transmitting data to the STA based on the determined transmission output value.

Then, in step S606, the AP 101 performs RU (frequency resource) allocation processing for each STA serving as a transmission destination. In a case where a plurality of STAs are determined as transmission destinations, the AP 101 allocates RUs (frequency resources) from the plurality of RUs included in the communication channel to be used, through the allocation processing described above with reference to FIG. 5. Specifically, among the plurality of STAs, the AP 101 allocates RUs closer to the band edge for STAs for which lower transmission output values have been determined, and allocates RUs farther from the band edge for STAs for which higher transmission output values have been determined. In other words, the AP 101 allocates individual RUs to the plurality of STAs by repeating the processing for allocating the RUs farthest from the band edge in order from the STA corresponding to the highest transmission output.

In this manner, among the plurality of STAs, the AP 101 performs allocation processing for allocating RUs closer to the band edge to STAs corresponding to lower transmission outputs, and allocating RUs farther from the band edge to STAs corresponding to higher transmission outputs. Once the allocation processing in step S606 is complete, the AP 101 advances the processing to step S607.

In step S607, for all the RUs used to transmit data frames, the AP 101 determines whether or not the transmission output value corresponding to the STA to which the RU is allocated is no greater than the maximum value of the transmission output set for that RU. Note that the maximum value of the transmission output for each RU is set in advance and stored in the storage unit 201, and is read out and used by the control unit 202 (the RU management unit 303).

If the transmission output value for any of the RUs exceeds the maximum value, the AP 101 returns the sequence from step S607 to step S605, and performs the processing of steps S605 to S607 again. In this case, if the data frames are transmitted in a state of maintaining the transmission output value setting and allocation for each RU, the signal strength in the predetermined out-of-band frequency may exceed the regulatory value. The AP 101 therefore determines the transmission output value and modulation scheme used for the STAs serving as transmission destinations as well as the data length (step S605) and performs the RU allocation processing for the STAs (step S606) again. At this time, it may be necessary for the AP 101 to reduce the transmission output value corresponding to each STA, and as a result, change the modulation scheme being used to a modulation scheme having a lower modulation level, in order to compensate for the drop in S/N for the STAs on the receiving side. On the other hand, it may be necessary to increase the data length in the data frames in order to ensure a sufficient communication data volume.

If the transmission output value for all the RUs is no greater than the maximum value in step S607, the AP 101 advances the processing to step S608. In step S608, the AP 101 transmits data frames to the plurality of STAs through OFDMA via a downlink using respective RUs allocated to that plurality of STAs, and then ends the processing according to the sequence in FIG. 6.

Although the foregoing embodiment uses FIGS. 4 to 6 to describe examples of RU allocation and transmission output value determination in downlink communication (data transmission by the AP 101), these techniques may be applied to uplink communication (data transmission by the STAs) as well.

As described above, the AP 101 in the present embodiment is a communication apparatus that performs wireless communication compliant with an IEEE 802.11 standard, and allocates individual RUs (frequency resources) for OFDMA communication to a plurality of STAs (user terminals). The AP 101 performs OFDMA communication with the plurality of STAs using respective RUs allocated to the plurality of STAs. When allocating the RUs, the AP 101 performs the allocation processing such that among the plurality of STAs, frequency resources closer to the edges of the usable frequency band are allocated to STAs corresponding to lower transmission outputs, and frequency resources farther from the edges are allocated to STAs corresponding to higher transmission outputs.

Allocating the RUs in OFDMA communication in this manner makes it possible to ensure sufficient transmission output for STAs that require high transmission outputs, even in cases of using a communication channel located at the band edge. Accordingly, it becomes possible to maintain the communication quality in such communication channels compared to cases where RUs of other communication channels are used, while satisfying the regulations for signal strengths in a predetermined out-of-band frequency. As such, according to the present embodiment, RUs (frequency resources) are allocated more appropriately in OFDMA communication so as to make it possible to use the necessary transmission output for each STA (user terminal).

According to the present disclosure, it becomes possible to use the necessary transmission output for each of user terminals by allocating frequency resources more appropriately in OFDMA communication.

### Other Embodiments

Embodiment(s) of the present disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has described exemplary embodiments, it is to be understood that some embodiments are not limited to the disclosed exemplary embodiments. The scope of the following claims is to be accorded the broadest interpretation so as to encompass all such modifications and equivalent structures and functions.

This application claims priority to Japanese Patent Application No. 2023-011218, which was filed on Jan. 27, 2023 and which is hereby incorporated by reference herein in its entirety.

What is claimed is:

1. A communication apparatus that performs wireless communication compliant with an IEEE 802.11 standard, the communication apparatus comprising:
at least one memory that stores a set of instructions; and
at least one processor that executes the instructions, the instructions, when executed, causing the communication apparatus to perform operations comprising:
executing allocation processing for allocating individual frequency resources to a plurality of user terminals; and
controlling communication such that OFDMA communication with the plurality of user terminals is performed using respective frequency resources allocated to the plurality of user terminals in the allocation processing,
wherein in the allocation processing, a frequency resource closer to an edge of a usable frequency band is allocated to a user terminal, among the plurality of user terminals, that corresponds to a lower transmission output, and a frequency resource farther from the edge is allocated to a user terminal, among the plurality of user terminals, that corresponds to a higher transmission output.

2. The communication apparatus according to claim 1,
wherein in setting of a maximum value of transmission output for each of the frequency resources used in the OFDMA communication, a higher maximum value is set for a frequency resource farther from the edge.

3. The communication apparatus according to claim 2,
wherein the setting of the maximum value of the transmission output is performed such that a signal strength at a predetermined out-of-band frequency does not exceed a regulatory value as a result of the frequency resources being used in the OFDMA communication.

4. The communication apparatus according to claim 2,
wherein the OFDMA communication is performed using a plurality of frequency resources included in one communication channel in the usable frequency band, and
a maximum value of transmission output across all of the frequency resources in the communication channel is higher in a case where the OFDMA communication is performed with the plurality of user terminals than in a case where OFDM communication is performed with a single user terminal using the communication channel.

5. The communication apparatus according to claim 1, wherein the operations further comprise:
executing determination processing for determining a transmission output value for each of the plurality of user terminals, and
wherein in the allocation processing, a frequency resource farther from the edge is allocated to a user terminal for which a higher transmission output value is determined by the determination processing.

6. The communication apparatus according to claim 5,
wherein in the determination processing, the transmission output value is determined for each of the plurality of user terminals such that a maximum value of transmission output set for the frequency resource allocated to each of the plurality of user terminals is not exceeded.

7. The communication apparatus according to claim 5,
wherein in the determination processing, for each of the plurality of user terminals, the transmission output value is determined for the user terminal based on a distance between the user terminal and the communication apparatus.

8. The communication apparatus according to claim 7, wherein the operations further comprise:
obtaining, for each of the plurality of user terminals, a measurement value related to the distance based on a difference between a strength of a signal transmitted by the communication apparatus and a strength of a signal received by the user terminal, and
wherein in the determination processing, for each of the plurality of user terminals, the transmission output value is determined for the user terminal based on the measurement value obtained for the user terminal.

9. The communication apparatus according to claim 7, wherein the operations further comprise:
determining, for each of the plurality of user terminals, a modulation scheme and a data length for data transmission to the user terminal, based on at least the transmission output value determined by the determination processing.

10. The communication apparatus according to claim 1,
wherein only in a case where the OFDMA communication is performed using a specific communication channel within the usable frequency band, the allocation processing is executed such that a frequency resource closer to the edge of the usable frequency band is allocated to a user terminal, among the plurality of user terminals, that corresponds to a lower transmission output, and a frequency resource farther from the edge is allocated to a user terminal, among the plurality of user terminals, that corresponds to a higher transmission output.

11. The communication apparatus according to claim 1,
wherein only in a case where the communication apparatus is used in a specific country, the allocation processing is executed such that a frequency resource closer to the edge of the usable frequency band is allocated to a user terminal, among the plurality of user terminals, that corresponds to a lower transmission output, and a frequency resource farther from the edge is allocated to a user terminal, among the plurality of user terminals, that corresponds to a higher transmission output.

12. The communication apparatus according to claim 1,
wherein each of the frequency resources used in the OFDMA communication is a resource unit (RU) constituted by a plurality of consecutive subcarriers.

13. A method for controlling a communication apparatus that performs wireless communication compliant with an IEEE 802.11 standard, the method comprising:
executing allocation processing for allocating individual frequency resources to a plurality of user terminals; and
controlling communication such that OFDMA communication with the plurality of user terminals is performed using respective frequency resources allocated to the plurality of user terminals in the allocation processing,
wherein in the allocation processing, a frequency resource closer to an edge of a usable frequency band is allocated to a user terminal, among the plurality of user terminals, that corresponds to a lower transmission output, and a frequency resource farther from the edge is allocated to a user terminal, among the plurality of user terminals, that corresponds to a higher transmission output.

14. A non-transitory storage medium storing a program for causing a computer to execute a method for controlling a communication apparatus that performs wireless communication compliant with an IEEE 802.11 standard, the method comprising:
executing allocation processing for allocating individual frequency resources to a plurality of user terminals; and
controlling communication such that OFDMA communication with the plurality of user terminals is performed using respective frequency resources allocated to the plurality of user terminals in the allocation processing,
wherein in the allocation processing, a frequency resource closer to an edge of a usable frequency band is allocated to a user terminal, among the plurality of user terminals, that corresponds to a lower transmission output, and a frequency resource farther from the edge is allocated to a user terminal, among the plurality of user terminals, that corresponds to a higher transmission output.
